(19) United States
(12) Patent Application Publication
(10) Pub. No.: US 2006/0294518 A1
(43) Pub. Date: Dec. 28, 2006

(54) Method, apparatus and system for a lightweight virtual machine monitor

(76) Inventors: Michael S. Richmond, Beaverton, OR (US); Michael D. Kinney, Olympia, WA (US)

Correspondence Address: INTEL CORPORATION, P.O. BOX 5326, SANTA CLARA, CA, 95056-5326, US

(21) Appl. No.: 11/169,953

(22) Filed: Jun. 28, 2005

(51) Int. Cl. G06F 9/455

(52) U.S. Cl. 718/1

(57) ABSTRACT

A lightweight virtual machine monitor (“LVMM”) allocates devices on a virtual host. In one embodiment, the LVMM identifies a primary and a secondary VM on the virtual host. The LVMM may expose various devices on the virtual host directly to the primary VM and provide these devices as virtual devices to the secondary partition.

### BACKGROUND

Interest in virtualization technology is growing steadily as processor technology advances. One aspect of virtualization technology enables a single host computer running a virtual machine monitor (“VMM”) to present multiple abstractions and/or views of the host, such that the underlying hardware of the host appears as one or more independently operating virtual machines (“VMs”). Each VM may function as a self-contained platform, running its own operating system (“OS”) and/or a software application(s). The VMM manages allocation of resources on the host and performs context switching as necessary to cycle between various VMs according to a round-robin or other predetermined scheme.

### BRIEF DESCRIPTION OF THE DRAWINGS

The present invention is illustrated by way of example and not limitation in the figures of the accompanying drawings in which like references indicate similar elements, and in which:

FIG. 1 illustrates an example of a typical virtual machine host;

FIG. 2 illustrates an embodiment of the present invention in further detail;

FIG. 3 illustrates an alternate embodiment of the present invention including multiple secondary VMs; and

FIG. 4 is a flowchart illustrating an embodiment of the present invention.

### DETAILED DESCRIPTION

Embodiments of the present invention provide a method, apparatus and system for a lightweight, application-specific virtual machine monitor. Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

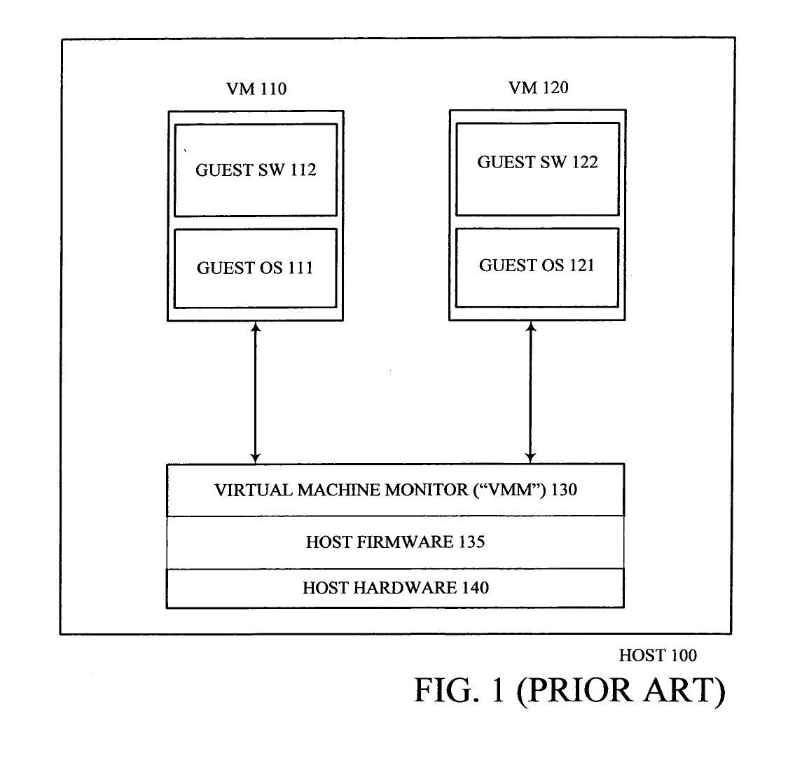

FIG. 1 illustrates an example of a typical virtual machine host platform (“Host 100”). As previously described, a virtual-machine monitor (“VMM 130”) typically runs on the host platform and presents an abstraction(s) and/or view(s) of the platform (also referred to as “virtual machines” or “VMs”) to other software. Although only two VM partitions are illustrated (“VM 110” and “VM 120”, hereafter referred to collectively as “VMs”), these VMs are merely illustrative and additional virtual machines may be added to the host. VMM 130 may be implemented in software (e.g., as a standalone program and/or a component of a host operating system), hardware, firmware and/or any combination thereof.

VM 110 and VM 120 may function as self-contained platforms respectively, running their own “guest operating systems” (i.e., operating systems hosted by VMM 130, illustrated as “Guest OS 111” and “Guest OS 121” and hereafter referred to collectively as “Guest OS”) and other software (illustrated as “Guest Software 112” and “Guest Software 122” and hereafter referred to collectively as “Guest Software”). Each Guest OS and/or Guest Software operates as if it were running on a dedicated computer rather than a virtual machine. That is, each Guest OS and/or Guest Software may expect to control various events and have access to hardware resources on Host 100.

Within each VM, the Guest OS and/or Guest Software may behave as if they were, in effect, running on Host 100's physical hardware (“Host Hardware 140”). Host Hardware 140 may include all devices on and/or coupled to Host 100, such as timers, interrupt controllers, keyboards, mouse, network controller, graphics controller, disk drives, CD- ROM drives and USB devices. VMM 130 has ultimate control over the events and these hardware resources and provides emulation of all the devices, as required, for each VM hosted by VMM 130.

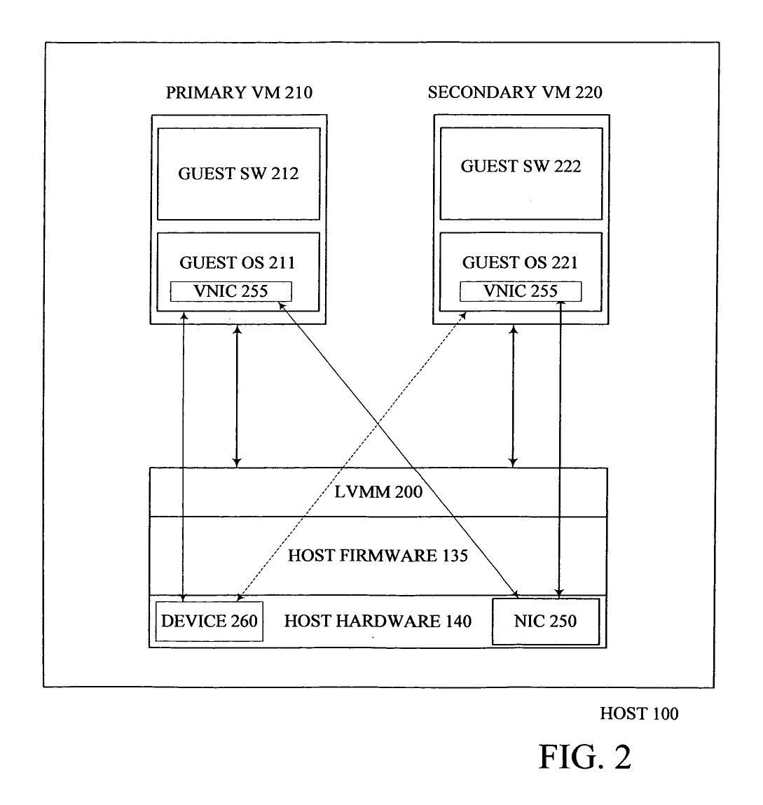

According to an embodiment of the present invention, a special-purpose virtual machine manager may be implemented to improve Guest OS performance. Specifically, according to an embodiment, the special-purpose virtual machine manager may allow one Guest OS untrapped (i.e., direct) access to any device that is not required by the other Guest OS on Host 100 and/or by VMM 130. FIG. 2 illustrates an embodiment of the present invention. Specifically, as illustrated, a Lightweight Virtual Machine Monitor (“LVMM 200”) may be implemented on Host 100. LVMM 200 may provide some of the traditional scheduling capabilities previously provided by VMM 130. LVMM 200 may also, however, include additional capabilities to enhance the performance of Host 100 by providing at least one Guest OS on Host 100 with direct access to Host 100's resources.

As illustrated in FIG. 2, LVMM 200 may identify a primary VM (i.e., one that typically utilizes more resources on Host 100 than the other VMs) to which it may “expose” various portions of Host Hardware 140. In the present example, this VM is assumed to be Primary VM 210, but embodiments of the present invention are not so limited. Thus, in one embodiment, the default devices used by Primary VM 210 such as the hard disk, floppy drive, CD ROM, keyboard, mouse and/or graphics controller, are not virtualized. Instead, Guest OS 211 on Primary VM 210 may be allowed direct access to these resources. Thus, as illustrated in FIG. 2, Guest OS 211 may be given direct access to Device 260. It is well known to those of ordinary skill in the art that direct access from a VM to resources may have a significant impact on improving the performance of the VM.

According to one embodiment of the present invention, the devices that are exposed to Primary VM 210 may be provided as virtual devices to the secondary partition on Host 100 (e.g., Secondary Secondary VM 220). As illustrated in FIG. 2, Device 260 may be exposed to Primary VM 210 and virtualized for Secondary VM 220 (virtual device not shown). Thus, according to this embodiment, Secondary VM 220's access to the device may be trapped and the trapped data may be shared with Guest VM 221 (on Secondary VM 220) through a protected shared memory area set up by LVMM 200. More specifically, LVMM 200 may provide services that allow Primary VM 210 and Secondary VM 220 to establish a memory region that is shared between the two VMs. This memory region may provide a high bandwidth, low latency communication path between Primary VM 210 and Secondary VM 220 and may be used, for example, to pass data (e.g., network packets) between the VMs without having to directly involve LVMM 200. This type of memory sharing scheme is well known to those of ordinary skill in the art and further description thereof is omitted herein in order not to unnecessarily obscure embodiments of the present invention.

In an alternate embodiment, a number of devices that are not assigned Primary VM 210 may be assigned directly to Secondary VM 220. Thus, for example, while the majority of devices on Host 100 may be assigned directly to Primary VM 210 and provided as virtual devices to Secondary VM 220, a minority of devices may be assigned directly to Secondary VM 220 and provided as virtual devices to Primary VM 210. Various allocation schemes may be practiced to optimize performance of Host 100 without departing from the spirit of embodiments of the present invention.

In one embodiment of the present invention, Guest OS 211 is assumed to be a Windows XP OS while Guest OS 221 is assumed to be a WinCE OS. According to this embodiment, Primary VM 210 remains the primary partition, and as a result, Windows XP may be the primary Guest OS while and WinCE may be the secondary Guest OS. All I/O devices on Host 100 other than the network interface card (“NIC 250”) may be “owned” by VM 210. Only motherboard resources required for the operation of the LVMM are hidden from Guest OS 211 in VM 210. According to one embodiment, these motherboard resources (e.g., NIC 250) may be provided as virtual resources to both Primary VM 210 and Secondary VM 220 (illustrated as VNIC 255 in both VMs). WinCE (Guest OS 221) may be used to host applications which add value to Host 100 through the execution of software on WinCE. Thus, for example, in one embodiment, a firewall program can be run on WinCE so that attacks on Primary VM 210 may be thwarted. According to an embodiment, LVMM 200's scheduling algorithm may also detect any crashes of Windows XP so that recovery software may be run on WinCE. It will be readily apparent to those of ordinary skill in the art that various such software applications may be run within the secondary partition (e.g., on WinCE) to improve the manageability of the primary partition (e.g., Windows XP).

According to an embodiment of the present invention, a few devices on Host 100 may still be virtualized, such as devices within Host 100 that are not typically visible to the user. In an alternate embodiment, NIC 250 may be virtualized despite the fact that the device is visible to the user. LVMM 200 may comprise enhancements made to an existing VMM and/or to other elements that may work in conjunction with an existing VMM. LVMM 200 may therefore be implemented in software (e.g., as a standalone program and/or a component of a host operating system), hardware, firmware and/or any combination thereof.

In one embodiment, LVMM may take advantage of features in Intel® Corporation's Virtual Technology computing environment (Intel® Virtualization Technology Specification for the IA-32 Intel® Architecture, April 2005, Intel® Virtualization Technology Specification for the Intel® Itanium Architecture (VT-i), Rev. 2.0, April 2005) but embodiments of the invention are not so limited. Instead, various embodiments may be practiced within other virtual environments that include similar features. According to an embodiment, VT provides support for virtualization with the introduction of a number of elements, including a new processor operation called Virtual Machine Extension (VMX). VMX enables a new set of processor instructions on PCs. In one embodiment, LVMM 200 may take advantage of VMX to identify and/or interact with the primary partition on Host 100. Further description of VMX and other features of VT are omitted herein in order not to unnecessarily obscure embodiments of the present invention.

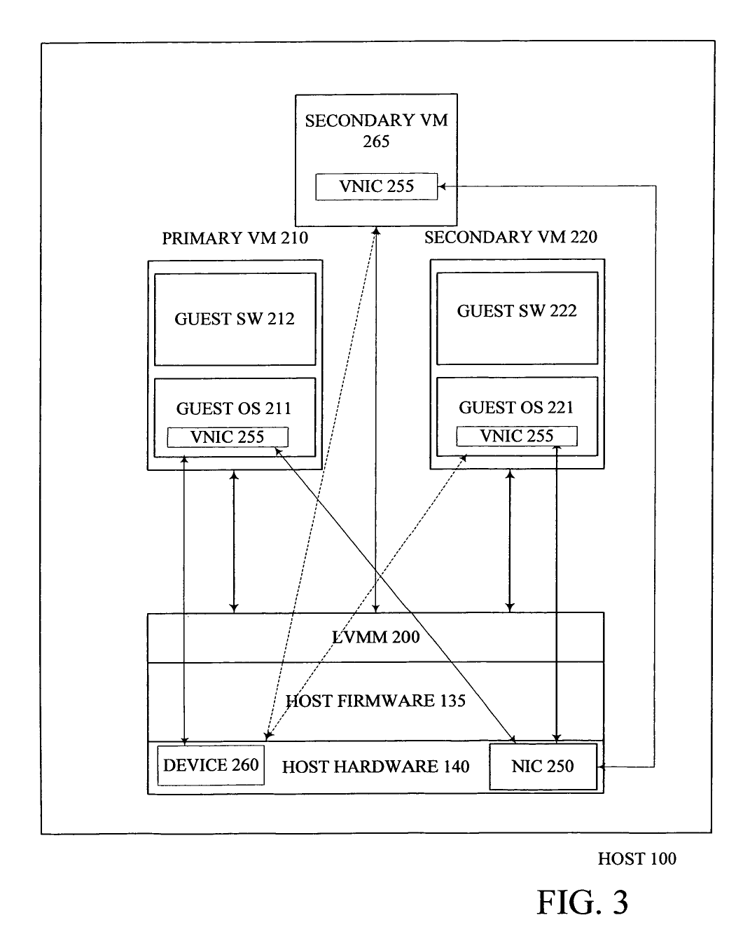

According to an embodiment, Host 100 may include one primary VM and one or more secondary VMs. In the event Host 100 includes more than one secondary VM, as illustrated in FIG. 3, the devices on Host 100 may be directly assigned to one or the other of the secondary VMs, while some number of devices may virtualized for access by all the VMs on Host 100. Thus, similar to the example in FIG. 2, Device 260 may be exposed directly to Primary VM 210 and virtualized for Secondary VM 220 and Secondary VM 265. In an alternate embodiment (not illustrated), Device 260 may also be exposed directly to one of the secondary VMs and virtualized fro Primary VM 210. It will be readily apparent to those of ordinary skill in the art that additional secondary VMs may be added without departing from the spirit of embodiments of the present invention. In one embodiment, the primary VM on Host 100 may be para-virtualized. The term “para-virtualized” is well known to those of ordinary skill in the art and includes components that are aware that they are running in a virtualized environment and that are capable of utilizing features of the virtualized environment to optimize performance and/or simplify implementation of a virtualized environment.

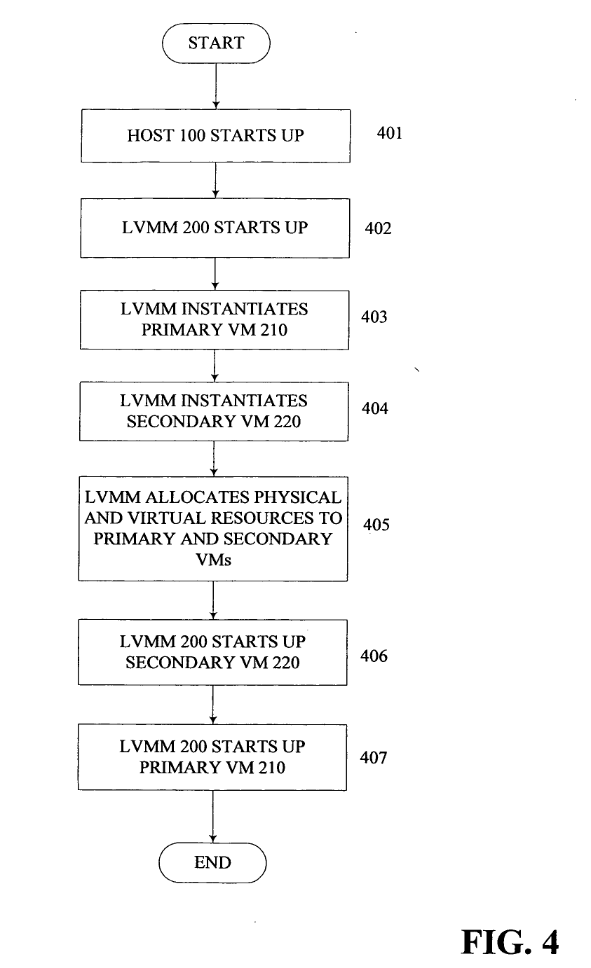

FIG. 4 is a flow chart illustrating an embodiment of the present invention in further detail. Although the following operations may be described as a sequential process, many of the operations may in fact be performed in parallel and/or concurrently. In addition, the order of the operations may be re-arranged without departing from the spirit of embodiments of the invention In one embodiment, in 401, Host 100 starts up and in 402, LVMM 200 starts up. LVMM 200 instantiates Primary VM 210 in 403 and Secondary VM 220 in 404 (and other secondary VMs, in some embodiments). LVMM 200 then allocates physical and virtual resources (e.g., memory, CPU cycles, devices, etc.) to Primary VM 210 and Secondary VM 220 in 405. As previously described, devices allocated to Primary VM 210 may be virtualized for Secondary VM 220 and some devices may be allocated to Secondary VM 220 and virtualized for Primary VM 210. In 406, LVMM 200 then starts Secondary VM 220 and in 407, LVMM 20 starts up Primary VM 210. In an alternate embodiment, LVMM 200 may start up Primary VM 210 prior to starting up Secondary VM 220.

The hosts according to embodiments of the present invention may be implemented on a variety of computing devices. According to an embodiment of the present invention, computing devices may include various components capable of executing instructions to accomplish an embodiment of the present invention. For example, the computing devices may include and/or be coupled to at least one machine-accessible medium. As used in this specification, a “machine” includes, but is not limited to, any computing device with one or more processors. As used in this specification, a machine-accessible medium includes any mechanism that stores and/or transmits information in any form accessible by a computing device, the machine-accessible medium including but not limited to, recordable/non-recordable media (such as read-only memory (ROM), random-access memory (RAM), magnetic disk storage media, optical storage media and flash memory devices), as well as electrical, optical, acoustical or other form of propagated signals (such as carrier waves, infrared signals and digital signals).

According to an embodiment, a computing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. One or more of these elements may be integrated together with the processor on a single package or using multiple packages or dies. A host bus controller such as a Universal Serial Bus (“USB”) host controller may be coupled to the bus(es) and a plurality of devices may be coupled to the USB. For example, user input devices such as a keyboard and mouse may be included in the computing device for providing input data. In alternate embodiments, the host bus controller may be compatible with various other interconnect standards including PCI, PCI Express, FireWire and other such existing and future standards.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A virtual machine (“VM”) host, comprising:
a lightweight virtual machine manager (“LVMM”);
a primary VM coupled to the LVMM;
a secondary VM coupled to the LVMM;
devices coupled to the VM host via the LVMM, the LVMM capable of exposing a plurality of the devices to the primary VM.

2. The VM host according to claim 1 wherein the LVMM is further capable of identifying the primary VM as a VM that utilizes more resources on the VM host than other VMs on the VM host.

3. The VM host according to claim 1 wherein the LVMM is further capable of virtualizing for the secondary VM the plurality of devices exposed to the primary VM.

4. The VM host according to claim 1 wherein the LVMM is further capable of exposing at least one of the plurality of devices to the secondary VM and virtualizing the at least one of the plurality of devices for the primary VM.

5. The VM host according to claim 1 wherein the secondary VM comprises a plurality of secondary VMs.

6. The VM host according to claim 5 wherein the LVMM is further capable of virtualizing for each of the secondary VMs the plurality of devices exposed to the primary VM.

7. The VM host according to claim 1 wherein the primary partition is para-virtualized.

8. A method comprising:
identifying a primary virtual machine (“VM”) and a secondary VM on a VM host;
exposing a plurality of devices on the VM host directly to the primary VM.

9. The method according to claim 8 further comprising virtualizing the plurality of devices on the VM host for the secondary VM.

10. The method according to claim 8 wherein identifying the primary VM comprises identifying a VM on the VM host that utilizes more resources on the VM host than other VMs on the VM host.

11. The method according to claim 8 further comprising exposing at least one of the plurality of devices to the secondary VM and virtualizing the at least one of the plurality of devices for the primary VM.

12. The method according to claim 8 further comprising identifying a plurality of secondary VMs.

13. The method according to claim 12 further comprising virtualizing for each of the plurality of secondary VMs the plurality of devices exposed to the primary VM.

14. The method according to claim 8 wherein the primary VM is para-virtualized.

15. An article comprising a machine-accessible medium having stored thereon instructions that, when executed by a machine, cause the machine to:
identify a primary virtual machine (“VM”) and a secondary VM on a VM host;
expose a plurality of devices on the VM host directly to the primary VM.

16. The article according to claim 15 wherein the instructions, when executed by the machine, further cause the machine to virtualize the plurality of devices on the VM host for the secondary VM.

17. The article according to claim 15 wherein the instructions, when executed by the machine, further cause the machine to identify the primary VM by identifying a VM on the VM host that utilizes more resources on the VM host than other VMs on the VM host.

18. The article according to claim 15 wherein the instructions, when executed by the machine, further cause the machine to expose at least one of the plurality of devices to the secondary VM and virtualizing the at least one of the plurality of devices for the primary VM.

19. The article according to claim 15 wherein the instructions, when executed by the machine, further cause the machine to identify a plurality of secondary VMs.

20. The article according to claim 19 wherein the instructions, when executed by the machine, further cause the machine to virtualize for each of the plurality of secondary VMs the plurality of devices exposed to the primary VM.

21. The article according to claim 13 wherein the primary VM is para-virtualized.
